(19) United States
(12) Patent Application Publication
(10) Pub. No.: US 2011/0059281 A1
(43) Pub. Date: Mar. 10, 2011

(54) DOUBLE-SIDED PRESSURE-SENSITIVE ADHESIVE SHEET

(75) Inventor: Hiroshi WADA, Ibaraki-shi (JP)

(73) Assignee: NITTO DENKO CORPORATION, Ibaraki-shi (JP)

(21) Appl. No.: 12/877,616

(22) Filed: Sep. 8, 2010

(30) Foreign Application Priority Data
Sep. 9, 2009 (JP) 2009-207672

(51) Int. Cl. B32B 33/00

(52) U.S. Cl. 428/41.8

(57) ABSTRACT

The present invention provides a double-sided pressure-sensitive adhesive (PSA) sheet that is provided with both adhesion performance and re-peelability that enables the PSA sheet to be preferably used for scheduled recyclable parts. The double-sided PSA sheet 1 is provided with a substrate 10, PSA layers 21 and 22 each applied to each side of the substrate 10, and a release liner 31 laminated onto at least the PSA layer 21. The PSA layer 21 contains a PSA component synthesized in an organic solvent. The release liner 31 has a release layer composed of a silicone release agent on at least the side that contacts the PSA layer 21. The release layer has an amount of silicone transfer of 10 kcps or less per unit surface area equivalent to a 30 mm diameter circle. The substrate 10 is composed of a non-woven fabric which has a grammage of 10 to 25 g/m², tensile strength in the lengthwise direction and tensile strength in the widthwise direction both falling within the range of 9 to 20 N/10 mm, and a grain ratio of 70 to 140%.

### BACKGROUND OF THE INVENTION

1. Field of the Invention

The present invention relates to double-sided pressure-sensitive adhesive (PSA) sheet that uses a non-woven fabric for a substrate and has a PSA layer formed by using a solvent-type PSA composition. More particularly, the present invention relates to a double-sided PSA sheet suitable for affixing to parts scheduled to be recycled.

The present application claims priority on the basis of Japanese Patent Application No. 2009-207672, filed on Sep. 9, 2009, the entire contents of which are incorporated herein by reference.

2. Description of the Related Art

Double-sided PSA sheets (also known as two-sided PSA sheets, double-faced PSA sheets or double-stick sheets) provided with a substrate are widely used in various industrial fields ranging from home appliances to automobiles and office equipment as adhering means that have satisfactory workability and high adhesion reliability. Non-woven fabric is preferably used for the substrate. Examples of background art documents relating to double-sided PSA sheets that use a non-woven fabric for the substrate include Japanese Patent Application Laid-open Nos. H7-70527, H9-272850, 2003-253228 and 2003-193006.

In recent years, it has become increasingly common to disassemble recyclable parts used in finished products following their use and reuse (recycle) those parts or their constituent materials. Consequently, a double-sided PSA sheet is sought that is suitable for bonding parts scheduled to be recycled (to also be referred to as scheduled recyclable parts).

### SUMMARY OF THE INVENTION

In order to reuse parts and the like that have been bonded by a double-sided PSA sheet, it is necessary to separate the parts at the bonded portions and remove (re-peel) the double-sided PSA sheet from the parts following separation. At this time, at the stage the parts are separated, the double-sided PSA sheet at the bonded portions may be shredded during the course of separation or intra-layer destruction may occur in which the substrate layer is internally torn into two layers. In addition, the problem of residue of the PSA layer remaining on an adherend (glue residue) may also occur. In such cases, when removing the double-sided PSA sheet from parts that have been separated, the destroyed double-sided PSA sheet and residue of the PSA layer must be removed from the surfaces of both separated parts, thereby considerably lowering the efficiency of part disassembly work. Consequently, double-sided PSA sheets used to bond scheduled recyclable parts are required to have peeling performance (re-peelability) that allows the sheets to be efficiently removed from parts. In addition, the double-sided PSA sheet is also required to have adhesion performance (adhesive strength, curved surface adhesiveness and the like able to maintain semi-permanent bonding) that is sufficient for fulfilling the inherent purpose of use of bonding parts in the same manner as typical conventional double-sided PSA sheets. Examples of the documents relating to adhesion performance and peeling performance of PSA sheets include Japanese Patent Application Laid-open Nos. H10-237393, H6-297645 and 2006-291121.

An object of the present invention is to provide a double-sided PSA sheet that is provided with both adhesive properties suitable for bonding and fixing parts as well as peeling performance that enables work for disassembling the parts to be carried out efficiently.

The inventors of the present invention focused on a solvent-type PSA composition for use as a PSA composition capable of forming a highly adhesive PSA layer. As a result, a technology was found in which, in addition to realizing high adhesive strength in a double-sided PSA sheet using this composition, also simultaneously realizes a high level of re-peelability that is the reciprocal property thereof, thereby leading to completion of the present invention.

The present invention provides a double-sided PSA sheet provided with a substrate composed of a non-woven fabric, a PSA layer applied to each side of the substrate, and a release liner laminated onto at least one of the PSA layers. The PSA layer contains, as a PDA component, a polymer synthesized in an organic solvent (and typically, formed from a solvent-type PSA composition). In addition, the release liner has a release layer composed of a silicone release agent on at least the side of the PSA layer (namely, the side in contact with the PSA layer). This PSA sheet satisfies all of the following characteristics (A) to (D):

(A) the non-woven fabric has a grammage of 10 to 25 g/m²;

(B) the non-woven fabric has tensile strength in the lengthwise direction (machine direction: MD) (to also be referred to as MD tensile strength) and tensile strength in the widthwise direction (cross-machine direction: CD) (to also be referred to as CD tensile strength) both falling within the range of 9 to 20 N/10 mm;

(C) the non-woven fabric has a grain ratio within the range of 70 to 140%; and

(D) the release layer has an amount of silicone transfer to Single-Sided Pressure-Sensitive Adhesive Tape No. 31B manufactured by Nitto Denko Corp. (to simply be referred to as the amount of silicone transfer) of 10 kcps or less per unit surface area equivalent to a 30 mm diameter circle when determined as the X-ray intensity of silicon (elementary Si) by X-ray fluorescence analysis.

Since the non-woven fabric has a grammage, MD tensile strength, CD tensile strength and grain ratio ((CD tensile strength/MD tensile strength)×100%) all within suitable ranges, is provided with suitable strength and has a satisfactory balance between strength in the lengthwise direction and strength in the widthwise direction, it is preferable for use as a substrate for supporting a PSA layer (PSA sheet substrate). In addition, since a substrate composed of a non-woven fabric is porous and enables adequate impregnation of a PSA composition (enabling it to completely penetrate to the inside), a PSA sheet can be formed in which the PSA layer is securely anchored to the substrate. Thus, a double-sided PSA sheet provided with a PSA sheet on each side of such a substrate tends to be resistant to the occurrence of problems such as intra-layer destruction and shredding when the PSA sheet is separated (re-peeled) from an adherend. In addition, since the amount of silicone transfer of the release layer as evaluated (determined) by the method described above is equal to or less than a prescribed amount, and transfer of silicone from the release layer to the PSA layer has little effect on adhesion performance, decreases in adhesive strength of the PSA layer can be inhibited. Thus, since a double-sided PSA sheet composed of these members realizes a satisfactory balance of the offsetting properties of high adhesive strength and satisfactory re-peelability (such as resistance to the formation of glue residue or the occurrence of shredding during re-peeling), it can be preferably used not only for bonding parts in various fields, but also for bonding parts that are scheduled to be recycled following use.

Furthermore, the amount of silicone transfer per unit surface area equivalent to a 30 mm diameter circle of the release layer as described above uses a value quantified according to the silicone transfer measurement method indicated below.

[Silicone Transfer Measurement Method]

A test piece is prepared by laminating the adhesive side of a piece of Single-Sided Pressure-Sensitive Adhesive Tape No. 31B manufactured by Nikko Denko Corp. to a release side (release layer) of a release liner to be measured. The test piece is then placed in a desiccator for 24 hours at 70° C. while applying a load of 5 kg followed by removing the load, taking out of the desiccator and holding for an additional 2 hours at 23° C. The release liner is then peeled from the test piece and the amount M (kcps) of Si present per unit surface area equivalent to a 30 mm diameter circle on the exposed adhesive surface is measured by X-ray fluorescence analysis. The amount N (kcps) of Si present per unit surface area equivalent to a 30 mm diameter circle on the adhesive surface of the above-mentioned PSA tape is measured as a blank by X-ray fluorescence analysis. The amount of silicone transferred from the release layer is the value obtained by subtracting N from M.

In a preferable aspect of the double-sided PSA sheet disclosed herein, the PSA sheet further satisfies at least one (and preferably both) of the following characteristics (E) and (F):

(E) the 180° peel adhesive strength for a stainless steel (SUS) plate (to be referred to as SUS adhesive strength) is 13 N/20 mm or more, and the 180° peel adhesive strength for a polypropylene (PP) plate (to be referred to as PP adhesive strength) is 9.5 N/20 mm or more; and

(F) glue residue (adhesion of residue of the PSA layer) is not present on an acrylonitrile-butadiene-styrene copolymer resin (ABS) plate in a glue residue test in which the PSA sheet is laminated onto the ABS plate for 7 days at 80° C. and then held for 24 hours at room temperature followed by peeling at a pulling speed of 5 mm/min and a peeling angle of 180°.

Since a double-sided PSA sheet having these characteristics demonstrates high adhesive strength to both highly polar materials such as SUS and low-polar materials such as PP, it can be preferably used in applications for bonding or fixing parts of various materials (such as metal parts, plastic parts and the like). At the same time, since it also demonstrates superior re-peelability that allows it to be removed (re-peeled) from an ABS or other resin material used as a material of various types of parts without leaving glue behind, it can be preferably used to bond scheduled recyclable parts made of various materials.

In another preferable aspect, the PSA sheet further satisfies the following characteristic (G):

(G) in an intra-layer destruction test in which each adhesive side is lined with a non-peeling substrate, held for 24 hours at 60° C., then cooled to room temperature and subjected to T-peeling at a peeling speed of 10 m/min, the PSA sheet has a surface area, over which intra-layer destruction has occurred in the non-woven fabric substrate, of 10% or less of the total surface area (lined area) of the substrate. Since a double-sided PSA sheet having this characteristic is resistant to the occurrence of intra-layer destruction when a part serving as an adherend is disassembled, the bother during removal of the PSA sheet from the part after separation can be further reduced. Thus, adhesion performance and re-peelability can be realized at even higher levels, thereby making this preferable.

In another preferable aspect, the organic solvent at least contains ethyl acetate. Namely, the PSA layer contains a polymer synthesized in an organic solvent that at least contains ethyl acetate. As a result, the toluene emission level and/or total emission level of volatile organic compounds (total VOCs; TVOC) of the PSA sheet can be reduced. Consequently, the PSA sheet can be preferably used in applications involving bonding or fixing of members of products used in closed spaces such as interior materials of automobiles and homes.

A preferable example of a silicone release agent for the PSA sheet disclosed herein is solvent-free silicone. Another preferable example is heat-curable silicone.

In another preferable aspect, the PSA sheet further satisfies the following properties (H) and (I):

(H) the amount of toluene emitted from the PSA sheet when the PSA sheet is held for 30 minutes at 80° C. is 20 μg or less per 1 g of the PSA layer; and

(I) the total amount of volatile organic compounds emitted from the PSA sheet when the PSA sheet is held for 30 minutes at 80° C. is 1000 μg or less per 1 g of the PSA layer.

A double-sided PSA sheet having low emission levels of toluene and TVOC even at high temperatures in this manner can be preferably used in applications such as bonding or fixing a member of finished products used in closed spaces as previously described as well as finished products requiring work at high temperatures or finished products that can reach a high temperature during use (such as automobiles or office equipment).

In another preferable aspect, the PSA layer contains, as a PSA component, an acrylic-based polymer obtained by polymerizing a monomer starting material at least containing an acrylic-based monomer represented by the general formula: CH₂═C(R¹)COOR². In this formula, R¹ represents a hydrogen atom or a methyl group, and R² represents an alkyl group having 2 to 14 carbon atoms. According to this PSA component, a PSA sheet can be realized that can be used with a non-woven fabric substrate having suitable strength and a release liner having a release layer for which the amount of silicone transfer is equal to or less than a prescribed value, and has an even higher degree of balance between adhesive properties and re-peelability.

In another preferable aspect, the PSA layer contains a polymerized rosin ester having a softening point of 80 to 180° C. as a tackifier (α). In another preferable aspect, the amount of the polymerized rosin ester contained in the PSA layer is 5 to 50 parts by weight based on 100 parts by weight of the polymer serving as a PSA component. In another preferable aspect, the PSA layer further contains a rosin ester having a softening point of lower than 120° C. as a tackifier (β). A double-sided PSA sheet that satisfies at least one of these conditions is able to realize an even higher degree of balance between adhesive properties and re-peelability.

In another preferable aspect, the PSA sheet further satisfies the following characteristic (J):

(J) a shear loss modulus G″ (Pa) of the PSA layer, which is measured as a function of temperature at a frequency of 1 Hz using a sample obtained by stamping out only the PSA layer into a columnar shape having a diameter of 7.5 mm and a height of 1 mm, reaches a maximum value within a temperature range of −45 to −20° C. A PSA sheet provided with a PSA layer having this characteristic is able to demonstrate even more superior re-peelability, such as resistance to the formation of glue residue during re-peeling, even if a long period of time has elapsed since having been adhered. Thus, this PSA sheet can be preferably used as a double-sided PSA sheet that is used to bond or fix scheduled recyclable parts that compose office equipment or home appliances.

In another preferable aspect, the PSA sheet further satisfies the following characteristic (K):

(K) there is no shredding of the PSA sheet in a shred test in which one side of the PSA sheet is laminated onto an ABS plate, the PSA sheet is pressed onto the ABS plate by passing a 2 kg roller back and forth over the PSA sheet, and the laminated PSA sheet is held for 7 hours at 80° C. and then for 24 hours at a temperature of 23° C. and a relative humidity (RH) of 50%, followed by peeling from the ABS plate at a pulling speed of 5 mm/min and a peeling angle of 180° in an environment at 23° C. and 50% RH. Since a double-sided PSA sheet having such superior re-peelability can be more reliably re-peeled from an adherend without shredding during the course of re-peeling, this double-sided PSA sheet is preferable not only for ordinary applications of double-sided PSA sheets (such as semi-permanent bonding or fixing of parts), but also for bonding or fixing of scheduled recyclable parts.

The PSA sheet disclosed herein is preferable able to further satisfy the following characteristic (L):

(L) a lift distance from the surface of an adherend (PP plate) is 3 mm or less in a curved surface conformability test to be subsequently described. A double-sided PSA sheet provided with this characteristic is preferable since it is not easily peeled from the adherend even in the case the bonding surface of a part to be fixed (adherend) is curved or has a level difference.

Since the double-sided PSA sheet disclosed herein has satisfactory adhesive properties as previously described (such as adhesive strength or curved surface adhesiveness), it can be preferably used in various types of applications in the same manner as ordinary double-sided PSA sheets (for example, applications for semi-permanently fixing a part or other adherend). In addition, since the double-sided PSA sheet also has the characteristic of being able to be re-peeled from an adherend without causing shredding or residual glue to remain as previously described, it is particularly preferable as a double-sided PSA sheet that is affixed to parts scheduled to be disassembled following use (and typically, parts scheduled to be recycled as well as parts requiring disassembly for categorized disposal).

### BRIEF DESCRIPTION OF THE DRAWINGS

FIG. 1 is a cross-sectional view schematically showing a typical example of the configuration of a PSA sheet relating to the present invention;

FIG. 2 is a cross-sectional view schematically showing another typical example of the configuration of a PSA sheet relating to the present invention;

FIG. 3 is a schematic drawing showing the initial state of a test piece laminated to an adherend in a curved surface conformability test; and

FIG. 4 is a schematic drawing showing a state in the end of a test piece laminated to an adherend has lifted from the adherend in a curved surface conformability test.

### DETAILED DESCRIPTION OF THE INVENTION

The following provides an explanation of preferred embodiments of the present invention. Matters other than those specifically mentioned in the present description that are required to carry out the present invention can be understood to be design matters of persons with ordinary skill in the art based on conventional technology in the art. The present invention can be carried out based on the contents disclosed in the present description and common technical knowledge in the art.

The PSA sheet provided by the present invention is provided with a substrate composed of a non-woven fabric, a PSA layers applied to each side of the substrate, and a release liner laminated onto at least one of the PSA layers. Articles referred to as PSA tape, PSA labels or PSA film and the like are can be included in the concept of this PSA sheet. Although the PSA layer is typically formed continuously, it is not limited thereto, but rather may also be formed in a regular or random pattern such as dots or stripes. In addition, the PSA sheet disclosed herein can be processed into various shapes such as a roll or individual sheets.

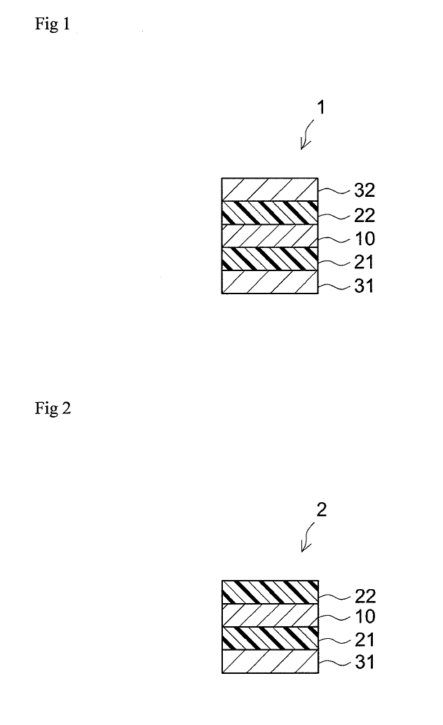

The PSA sheet disclosed herein (which may be in the form of a long strip such as tape) can have a cross-sectional structure schematically shown in FIG. 1 or FIG. 2. A double-sided PSA sheet 1 shown in FIG. 1 has a configuration in which PSA layers 21 and 22 are respectively provided on both sides of a non-woven fabric substrate 10, and the PSA layers 21 and 22 are respectively protected by release liners 31 and 32 in which at least the PSA layer side is a release side (namely, a release layer not shown is at least applied to the PSA layer side). A double-sided PSA sheet 2 shown in FIG. 2 has a configuration in which the PSA layers 21 and 22 are respectively provided on each side (non-peeling) of the substrate 10, and one of the PSA layers 21 is protected by a first release side of the release liner 31 in which each side is a release side (namely, a release layer not shown is applied to each side). The PSA sheet 2 can employ a configuration in which the PSA layer 22 is contacted with a second release surface of the release liner 31 and the release layer 22 is also protected by the release liner 31 by winding the PSA sheet 2. Although the interfaces between the non-woven fabric substrate 10 and the PSA layers 21 and 22 are respectively represented with straight lines in FIGS. 1 and 2 in order to facilitate understanding, in actuality, at least a portion of each of the PSA layers 21 and 22 penetrates into the non-woven fabric substrate 10. The PSA layers 21 and 22 penetrate to inside the substrate 10 and preferably form a state in which they are connected by these penetrating portions within the substrate 10.

A non-woven fabric can be used for the substrate. Although there are no particular restrictions on the fibers that compose this non-woven fabric, examples of fibers include one type or two or more types of fibers selected from hemp such as manila hemp, cellulose-based fibers such as rayon or acetate, wood fibers such as wood pulp, and synthetic fibers such as polyester fiber, polyvinyl alcohol (PVA) fiber, polyamide fiber, polyolefin fiber or polyurethane fiber. Manila hemp is particularly preferable since it has thick, long fibers and facilitates the obtaining of suitable strength. The “non-woven fabric” referred to here refers to a concept indicating non-woven fabric for PSA sheets used mainly in fields such as PSA tape and other PSA sheets, and typically refers to non-woven fabric that is produced using an ordinary papermaking machine (also referred to as “paper”).

The grammage of the non-woven fabric substrate is about 10 g/m² or more and typically about 10 to 25 g/m² (characteristic (A)). This grammage is preferably about 14 to 25 g/m² (and more preferably 17 to 25 g/m²). For example, tensile strength to be subsequently described can be made to be within a suitable range by making the grammage within the range of 10 to 25 g/m². If the grammage is excessively low, the strength (such as tensile strength) of the non-woven fabric substrate may be inadequate.

The non-woven fabric has MD tensile strength and CD tensile strength when pulled by a tensile tester at a speed of 300 mm/min in an environment at 23° C. and 50% RH of about 9 to 20 N/10 mm for both (characteristic (B)). The tensile strength in each MD and CD direction is preferably about 9 to 18 N/10 mm (and more preferably 9 to 14 N/10 mm). If either of these tensile strengths is excessively low, the strength (such as so-called “stiffness”) of the PSA sheet may be inadequate resulting in considerable decreases in handling ease and processing ease. If the tensile strengths of both are excessively high, and curved surface conformability of the PSA sheet decreases, causing the PSA sheet to peel from an adherend in the case the adhered surface is curved or has level differences.

The non-woven fabric substrate uses that in which the MD and CD tensile strengths are within the above ranges (characteristic (B)), and the grain ratio, which is represented as a percentage of the ratio of CD tensile strength to MD tensile strength, is about 70 to 140% (characteristic (C)). This grain ratio is preferably within the range of about 80 to 120%. If the grain ratio is too low or too high (namely, if the tensile strength in either direction is too low or too high resulting in improper balance between MD tensile strength and CD tensile strength), handling ease and processing ease of the resulting PSA sheet may decrease (for example, may stretch easily). In addition, work efficiency when re-peeling the PSA sheet from an adherend may also decrease (for example, may shred easily in one direction). Furthermore, the grain ratio can be controlled according to the production method of the non-woven fabric or the like. Although there are no particular limitations on the production method used, the grain ratio can be made to approach 100% by, for example, using an angled short-wire papermaking machine.

Although the thickness of the non-woven fabric substrate can generally be suitably determined corresponding to the grammage, from the viewpoints of ensuring adequate strength and inhibiting intra-layer destruction, the preferable thickness is about 40 to 150 μm (more preferably 50 to 100 μm, and even more preferably 70 to 100 μm). If the non-woven fabric is excessively thin, strength tends to be inadequate and intra-layer destruction may occur easily. If the non-woven fabric is excessively thick, curved surface conformability when affixing to a curved surface may decrease, thereby causing the non-woven fabric to peel from an adherend in the case the adhered surface is curved or has level differences.

Furthermore, the PSA sheet disclosed herein preferably has a lift distance of 3 mm or less (characteristic (L)), and preferably 2 mm or less, when peeled from the surface of an adherend in a curved surface conformability test carried out according to the method described in the examples.

The PSA layer of the PSA sheet disclosed herein contains one type of two or more types of an acrylic-based, rubber-based or silicone-based PSA component (adhesive polymer) synthesized in an organic solvent. The PSA layer is typically formed from a PSA composition containing one type or two or more types of these adhesive polymers. A PSA composition containing an acrylic-based polymer (acrylic-based PSA composition) synthesized in an organic solvent is used particularly preferably from the viewpoints of penetrability of the PSA layer into the non-woven fabric (which can be dependent on the viscosity of the PSA composition) and the adhesive strength, re-peelability and so on of the PSA sheet.

The acrylic-based polymer (PSA component) can be synthesized from a monomer starting material containing as a primary monomer (monomer component accounting for 60% by weight or more (typically, 60 to 98% by weight, and for example, 60 to 90% by weight) of the total monomer component) an alkyl (meth)acrylate having an alkyl group having 2 to 14 carbon atoms (the range of the number of carbon atoms may also be described as C₂₋₁₄). In the present description, “(meth)acrylate” refers inclusively to acrylate and methacrylate. Similarly, “(meth)acryloyl” refers inclusively to acryloyl and methacryloyl, while “(meth)acrylic” refers inclusively to acrylic and methacrylic.

Examples of the alkyl (meth)acrylates having a C₂₋₁₄ alkyl group include ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isoamyl (meth)acrylate, neopentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, bornyl (meth)acrylate, isobornyl (meth)acrylate, undecyl (meth)acrylate, dodecyl (meth)acrylate, tridecyl (meth)acrylate and tetradecyl (meth)acrylate. These alkyl (meth)acrylates can be used as one type alone or as two or more types in combination. Alkyl (meth)acrylates having a C₄₋₉ alkyl group are particularly preferable. Particularly preferable examples include C₄ butyl acrylate (BA) and C₈ 2-ethylhexyl acrylate (2EHA). For example, BA alone or 2EHA alone may be used for the primary monomer, only the two types of BA and 2EHA may be used, or another alkyl (meth)acrylate may be used by adding to a combination of BA and 2EHA. In the case of combining the use of at least BA and 2EHA for the primary monomer, the ratio of BA to the total amount of both can be selected from the range of, for example, 30% by weight to less than 100% by weight (preferably 50% by weight to less than 100% by weight, and more preferably 70% by weight to less than 100% by weight), and the amount of 2EHA may be suitably determined in accordance therewith.

The monomer starting material can contain one type or two or more types of a copolymerizable monomer for enhancing adhesive properties such as cohesive strength in addition to the primary monomer. Examples of such copolymerizable monomers include methyl (meth)acrylate, vinyl esters such as vinyl acetate, aromatic vinyl compounds such as styrene or vinyl toluene, (meth)acrylic acid esters of cyclic alcohols such as cyclopentyl (meth)acrylate or isobornyl (meth)acrylate, and (meth)acrylic acid esters of polyvalent alcohols such as neopentyl glycol di(meth)acrylate, hexanediol di(meth)acrylate, propylene glycol di(meth)acrylate, trimethylolpropane tri(meth)acrylate, tetramethylolmethane tri(meth)acrylate or dipentaerythritol hexa(meth)acrylate. A particularly preferable example of a copolymerizable monomer is vinyl acetate.

The monomer starting material can also contain one type or two or more types of other copolymerizable monomers in addition to the monomer components described above, examples of which include ethylenic unsaturated monomers having one type or two or more types of functional groups selected from carboxyl groups, hydroxyl groups, amino groups, amido groups, epoxy groups and alkoxysilyl groups and the like (functional group-containing monomers). These functional group-containing monomers can be useful for introducing crosslinking sites into the acrylic-based polymer. The types and content ratios (copolymerization ratios) of the functional group-containing monomers can be suitably set in consideration of the type and amount of crosslinking agent used, the type of crosslinking reaction, the desired degree of crosslinking (crosslinking density) and the like.

The PSA composition used in the PSA sheet disclosed herein can be a solvent-type PSA composition obtained by subjecting a monomer starting material as described above to polymerization in an organic solvent (solution polymerization). There are no particular limitations on the form of the polymerization method, and polymerization can be carried out by suitably employing various known types of monomer supply methods, polymerization conditions (such as polymerization temperature, polymerization time and polymerization pressure) and materials used (such as polymerization initiator) according to a form similar to conventionally known ordinary solution polymerization. For example, a batch charging method in which all monomer starting materials are supplied to a polymerization vessel all at once, a continuous supply method in which the monomer starting materials are gradually dropped in, or a divided supply method in which the raw materials are supplied at prescribed times after dividing into several aliquots, can be employed for the monomer supply method. All or a portion of the raw material monomers may also be dissolved in advance in an organic solvent followed by supplying the monomer solution to a reaction vessel.

Various polymerization initiators can be used without any particular limitations as a polymerization initiator. Examples of polymerization initiators that can be used include radical-based initiators (for example, azo-based initiators such as 2,2′-azobisisobutyronitrile (AIBN), peroxide-based initiators such as benzoyl peroxide), anionic-based initiators and Ziegler-Natta catalysts. Normally, an oil-soluble polymerization initiator is used preferably.

Although the amount of polymerization initiator used can be suitably selected corresponding to the type of the initiator, the types of monomers (monomer starting material composition) and the like, normally it is suitably selected from the range of, for example, about 0.01 to 1 part by weight based on 100 parts by weight of the monomer starting materials. Any of a batch charging method, in which substantially the entire amount of the polymerization initiator used is placed in a reaction vessel prior to starting polymerization of the monomer starting materials (and typically, an organic solvent solution of the polymerization initiator is prepared in the reaction vessel), a continuous supply method or a divided supply method and the like can be preferably used as a polymerization initiator supply method. A batch charging method, for example, can be used preferably from the viewpoints of ease of the polymerization procedure, ease of process management and the like. The polymerization temperature can be, for example, within the range of about 20 to 100° C. (and typically, 40 to 80° C.). In addition, the polymerization time can be suitably selected along with the polymerization temperature so that a desired molecular weight and molecular weight distribution are obtained. Although there are no particular limitations thereon, the solution polymerization can be carried out so that the weight average molecular weight (Mw) of the resulting acrylic-based polymer is, for example, about 1×10⁵ to 1×10⁶ as standard polystyrene.

In a preferable aspect of the PSA sheet disclosed herein, the PSA composition at least contains one type or two or more types of polymerized rosin ester as a tackifier (α). In particular, a polymerized rosin ester in which the softening point as measured according to the ring and ball method is about 80 to 180° C. (and more preferably 120 to 180° C.) is preferable. The incorporated amount of the tackifier (α) as non-volatile component (solid fraction) is, for example, preferably about 5 to 50 parts by weight (and more preferably about 10 to 40 parts by weight) based on 100 parts by weight of the adhesive polymer.

Examples of commercially available polymerized rosin esters that are used preferably include, but are not limited to, Pencel D-125, Pencel D-135, Pencel D-160, Pencel KK and Pencel C manufactured by Arakawa Chemical Industries, Ltd.

In addition to the polymerized rosin ester, the PSA composition can also contain one type of two or more types of another tackifier (β). Examples of this tackifier (β) include terpene resins, coumarone-indene resins, aliphatic petroleum resins (C5-based petroleum resins: resins obtained by polymerizing monomers obtained as C5-based petroleum fractions), aromatic petroleum resins (C9-based petroleum resins: resins obtained by polymerizing monomers obtained as C9-based petroleum fractions), C5-C9-based copolymerized petroleum resins, terpene phenolic resins and hydrides thereof (also referred to as hydrogenation products or hydrogenates), ester compounds, rosin acids, polymerized rosins and rosin esters. In particular, rosin esters in which the softening point as measured according to the ring and ball method is lower than 120° C. (more preferably 100° C. or lower, even more preferably 80° C., and for example, under 80° C.) are used preferably. The incorporated amount of the tackifier (β) as non-volatile component (solid fraction) can be, for example, about 5 to 50 parts by weight (and more preferably about 10 to 40 parts by weight) based on 100 parts by weight of the adhesive polymer.

Examples of commercially available rosin esters that can be used preferably include, but are not limited to, Super Ester A-75, Super Ester A-100 and Super Ester A-115 manufactured by Arakawa Chemical Industries, Ltd.

A crosslinking agent selected from ordinary crosslinking agents may be incorporated in the PSA composition used in the PSA sheet as necessary, examples of which include isocyanate-based crosslinking agents, epoxy-based crosslinking agents, carbodiimide-based crosslinking agents, hydrazine-based crosslinking agents, oxazoline-based crosslinking agents, aziridine-based crosslinking agents, metal chelate-based crosslinking agents and silane coupling agents. These crosslinking agents can be used alone or two or more types can be used in combination.

The PSA composition can contain one type or two or more types of various additives commonly used in the field of PSA compositions as other arbitrary components within a range that does not impair the effects according to the present invention, examples of which include leveling agents, plasticizers, colorants such as pigments or dyes, stabilizers, preservatives and anti-aging agents. In addition, a known wetting agent may also be added to the PSA composition to enhance penetration of PSA into the non-woven fabric substrate. The addition of this wetting agent is particularly effective in the case of forming a PSA layer on at least one side of the non-woven fabric substrate by applying a direct method to be described later. Conventionally known types of these various additives can be used in accordance with ordinary methods.

Various organic solvents can be used as a solvent (or dispersion medium) of the PSA composition, examples of which include ethyl acetate, toluene, methyl ethyl ketone and methyl isobutyl ketone. One type of these solvents can be used alone or two or more types can be used as a mixture. The use of an organic solvent enhances penetration into the substrate of the PSA composition (and therefore penetration and anchoring of the substrate to the PSA layer), while also contributing to inhibition of an intra-layer destruction surface area ratio to be described later. Ethyl acetate is used preferably from the viewpoints of ensuring adhesion performance suitable for bonding parts and reducing emission levels of VOCs.

The viscosity of the PSA composition at room temperature (23° C.) is preferably about 0.1 to 100 Pa·s (more preferably 1 to 50 Pa·s, and even more preferably 5 to 30 Pa·s). The PSA composition is able to adequate penetrate to the inside of even a comparatively thick non-woven fabric substrate. If viscosity is excessively low, the PSA composition applied onto the substrate ends up running off, thereby making it difficult to control the thickness of the PSA layer. If viscosity is excessively high, it becomes difficult for the PSA composition to penetrate into the substrate or there may be increased susceptibility to the occurrence of intra-layer destruction during re-peeling. There are no particular limitations on the method used to control the viscosity of the PSA composition, and viscosity can be adjusted to a suitable viscosity by, for example, changing the solid fraction content or the molecular weight of the adhesive polymer.

The surface area over which intra-layer destruction occurs in the non-woven fabric substrate (intra-layer destruction surface area ratio) (and which can be estimated visually) of the PSA sheet disclosed herein when used as a double-sided PSA sheet laminated to a scheduled recyclable part is preferably about 10% or less of the total surface area of the substrate (namely, the surface area of the adhesive side (bonding surface area)) as determined in an intra-layer destruction rate test in which each adhesive side is lined with a non-peeling substrate (such as aluminum foil), held for 24 hours at 60° C., then cooled to room temperature and subjected to T-peeling at a peeling speed of 10 m/min (characteristic (G)). This intra-layer destruction surface area ratio is preferably about 8% or less (more preferably about 6% or less and even more preferably about 4% or less). If the intra-layer destruction surface area ratio is excessively large, a PSA sheet in which at least a portion thereof has separated into two layers may remain on both parts when a part that is an adherend (and typically consisting of two bonded parts) is disassembled for the purpose of recycling, and since the total surface area of the destroyed PSA sheet that requires removal increases greatly beyond the bonding surface area, the efficiency of disassembly work for that part may decrease considerably.

From the viewpoint of inhibiting intra-layer destruction and reduce the intra-layer destruction surface area ratio, a PSA layer is preferably provided on each side of the substrate so that the PSA penetrates completely inside the substrate (namely, so that the PSA layer on each side takes on a continuous (fused) form that passes through the gaps between the fibers that compose the non-woven fabric). As a result, a structure can be realized in which fibers that compose the non-woven fabric are mutually adhered by the PSA component contained in the PSA layer throughout the entire thickness of the non-woven fabric. According to this structure, the intra-layer destruction surface area ratio can be reduced without causing significant decrease in adhesive strength. If penetration of the PSA into the substrate is inadequate, there may be increased susceptibility to the occurrence of intra-layer destruction at that portion during re-peeling.

There are no particular limitations on the method used to provide the PSA layer on each side of the substrate. Normally, a method selected from: (1) a method in which a PSA layer is formed on a release liner by applying (typically, coating) a PSA composition to the release liner and drying, then a lined PSA layer is transferred (laminated) by laminating to a substrate (to be referred to as a transfer method), and (2) a method in which a PSA composition is applied (typically, coated) directly to a substrate (to be referred to as a direct coating method or direct method) is preferably respectively applied to each side. For example, a double-sided PSA sheet may be produced by applying the transfer method to each side of a substrate (transfer-transfer method), or a double-sided PSA sheet may be produced by applying the transfer method to a first side of the substrate (typically, the side on which the PSA layer is initially provided) and applying the direct coating method to a second side (transfer-direct method). Applying (coating) of the PSA layer to each side can be carried out sequentially or simultaneously. For example, a PSA composition having a suitable viscosity can be simultaneously coated directly from each side of a non-woven fabric substrate. As a result, the PSA composition is easily able to more uniformly penetrate inside the non-woven fabric substrate even if the non-woven fabric substrate is comparatively thick.

Coating of the PSA composition can be carried out using, for example, a die coater, gravure roll coater, reverse roll coater, kiss roll coater, dip roll coater, bar coater, air knife coater, spray coater, brush coater or other general-purpose coater. For example, a PSA composition having a suitable viscosity can be made to efficiently penetrate inside the substrate by directly coating the PSA composition onto each side of the substrate simultaneously using a die coater.

From the viewpoint of ensuring adequate adhesion performance, the thickness of the PSA layer after drying and/or curing (thickness from the surface of the substrate to the surface of the PSA layer) is preferably about 10 μm to 1000 μm (and more preferably 30 μm to 100 μm).

From the viewpoints of improving removal efficiency of solvent, residual monomers and other volatile components in the PSA composition (namely, reducing emission levels of VOCs) and accelerating the crosslinking reaction, drying of the composition is preferably carried out while heating. Although there are no particular limitations thereon, a drying temperature of, for example, about 40 to 140° C. (and preferably 60 to 120° C.) can be employed. The drying time can be made to be, for example, about 1 to 5 minutes. The crosslinking reaction can be further accelerated by aging (curing) the dried PSA composition under suitable conditions (for example, in an environment at a temperature of about 40° C. or higher (and typically about 40 to 70° C.)).

The shear loss modulus G″ (Pa) of the PSA layer of the PSA sheet disclosed herein measured as a function of temperature at a frequency of 1 Hz using a sample obtained by stamping out only the PSA layer into a columnar shape having a diameter of 7.5 mm and a height of 1 mm preferably reaches a maximum value within a temperature range of −45 to −20° C. (characteristic (J)). In other words, when changes in the shear loss modulus G″ are plotted versus temperature change with temperature on the X axis and the shear loss modulus G″ on the Y axis, the peak is preferably within the range of −45 to −20° C. A PSA sheet provided with a PSA layer having this characteristic is able to be re-peeled (removed) from an adherend without leaving behind prominent glue residue even a long period of time has elapsed since having been adhered. Thus, this PSA sheet is particularly useful as a PSA sheet for bonding scheduled recyclable parts such as those in office equipment or home appliances. If the temperature at which the peak of the shear loss modulus G″ appears is excessively lower than −45° C., there may be prominent residual glue present when re-peeling following long-term storage (in the case of a long period of time having elapsed after having been adhered). In addition, if the temperature at which the peak of the shear loss modulus G″ appears is excessively higher than −20° C., adhesion performance required for bonding parts may decrease.

The shear loss modulus G″ can be controlled according to the composite ratio of the monomer starting material, the softening point of the tackifier and/or the content thereof and the like. Furthermore, a graph indicating changes in the shear loss modulus G″ relative to temperature can be obtained by, for example, analyzing shear vibrations transmitted to a second circular surface when applying shear vibrations at a frequency of 1 Hz to a first circular surface of the columnar sample at each set temperature using a viscoelasticity analyzer.

The PSA sheet disclosed herein is provided with a release liner laminated onto at least one PSA layer applied to each side of a substrate. This release liner contains a substrate and a release layer (releasable coat) at least applied to the side that contacts the PSA layer. This release liner is formed so that the amount of silicone transfer as measured using the previously described method when using a silicone release agent is 10 kcps or less (characteristic (D)). This amount of silicone transfer is preferably 6 kcps or less. Specific examples of the silicone release agent include heat-curable silicone release agents, which are cured by applying heat after coating, and ionizing radiation-curable silicone release agents, which are cured by applying ionizing radiation (such as ultraviolet rays, α rays, β rays, γ rays, neutron beam or electron beam). One type of these silicone release agents can be used alone or two or more types can be used in combination. A heat-curable silicone release agent is used preferably from the viewpoints of economy and simplicity of the apparatus required for coating.

In addition, these release agents may be of solvent-free type that does not contain solvent, or solvent type in which the release agent is dissolved or dispersed in an organic solvent. In addition, a release agent for which viscosity has been adjusted so as to facilitate application (and typically, coating) by mixing a suitable amount of a solvent having comparatively low surface tension into a solvent-free release agent may also be used. From the viewpoints of environmental health during release layer formation and further reduction of TVOC level, a solvent-free silicone release agent is used preferably that can be applied as is without substantially containing an organic solvent.

The heat-curable silicone release agent normally contains an organohydrogenpolysiloxane and an organopolysiloxane having an aliphatic unsaturated group, and may be of the solvent-free type or solvent type. A thermal addition reaction-curable silicone release agent, which is cured by crosslinking carried out by an addition reaction using heat, is used particularly preferably.

Examples of this thermal addition reaction-curable silicone release agent that can be used include release agents containing a polysiloxane having a hydrogen atom (H) bonded to a silicon atom (Si) in a molecule thereof (Si—H group-containing polysiloxane) and a polysiloxane containing a functional group (Si—H group-reactive functional group) having reactivity with Si—H bonds (covalent bonds between Si and H) in a molecule thereof (Si—H group-reactive polysiloxane). These release agents are cured by undergoing crosslinking by an addition reaction between Si—H groups and Si—H group-reactive functional groups.

In the Si—H group-containing polysiloxane, Si to which H is bonded may be Si in the main chain or Si in a side chain. A polysiloxane containing two or more Si—H groups in a molecule thereof is preferable. Examples of polysiloxanes containing two or more Si—H groups include dimethylhydrogensiloxane-based polymers such as poly(dimethylsiloxane-methylsiloxane).

On the other hand, a polysiloxane of a form in which an Si—H group-reactive functional group or side chain containing such a group is bonded to Si that forms a siloxane-based polymer main chain (backbone) (such as Si on the end of the main chain or Si within the main chain) can be used for the Si—H group-reactive polysiloxane. In particular, a polysiloxane in which a Si—H group-reactive functional group is bonded directly to Si in the main chain is preferable. In addition, a polysiloxane containing two or more Si—H group-reactive functional groups in a molecule thereof is preferable. Examples of Si—H group-reactive functional groups include alkenyl groups such as a vinyl group and a hexenyl group.

Examples of siloxane-based polymers that form the main chain component include polydialkylsiloxanes such as polydimethylsiloxane, polydiethylsiloxane or polymethylethylsiloxane (wherein the two alkyl groups may be the same or different), polyalkylarylsiloxanes and polymers obtained by polymerizing a plurality of Si-containing monomers such as poly(dimethylsiloxane-methylsiloxane). A particularly preferable example of a main chain polymer is polydimethylsiloxane.

A thermal addition reaction-curable silicone release agent that contains a polysiloxane containing two or more Si—H groups in a molecule thereof and a polysiloxane containing two or more Si—H group-reactive functional groups in a molecule thereof is used particularly preferably.

There are no particular limitations on the mixing ratio of the Si—H group-containing polysiloxane and the Si—H group-reactive polysiloxane contained in the release agent provided it is within a range that allows the release agent to be adequately cured and the amount of silicone transfer to be as previously described. The mixing ratio is preferably selected so that the number of moles mₐ of Si of the Si—H group and the number of moles m_{b} of the Si—H group-reactive functional group is such that mₐ≧m_{b}, and normally the ratio of mₐ:m_{b} is preferably about 1:1 to 2:1 (and more preferably, 1.2:1 to 1.6:1).

A catalyst for accelerating the crosslinking reaction may be added to the previously described heat-curable silicone release agent. Examples of such a catalyst include platinum-based catalysts such as platinum fine particles or platinous chloride and derivatives thereof. Although there are no particular limitations on the amount of catalyst added, it is preferably selected from the range of, for example, 0.1 to 1000 ppm (and more preferably 1 to 100 ppm) based on the Si—H group-reactive polysiloxane.

A heat-curable silicone release agent consisting of a mixture of suitably prepared or acquired components as previously described or a commercially available product containing the components described above can be used for the heat-curable silicone release agent. In addition, known, commonly used additives such as fillers, antistatic agents, antioxidants, ultraviolet absorbers, plasticizers or colorants (such as dyes or pigments) may also be suitably added as necessary in addition to the above-mentioned components.

On the other hand, a solvent-free type or solvent type can be used for the ionizing radiation-curable silicone release agent. A UV-curable silicone release agent that undergoes a crosslinking reaction as a result of being irradiated with UV light is used particularly preferably.

A release agent that undergoes a chemical reaction such as cationic polymerization, radical polymerization, radical addition polymerization or hydrosilylation as a result of being irradiated with UV light can be used for the UV-curable silicone release agent. A UV-curable silicone release agent that is cured by cationic polymerization is used particularly preferably.

A release agent containing an epoxy group-containing polysiloxane of a form in which at least two epoxy groups are respectively bonded to Si that forms the main chain (backbone) of a siloxane-based polymer (such as Si on the end of a side chain or Si within the main chain) and/or Si contained in a side chain, either directly or through a divalent group (examples of which include an alkylene group such as a methylene group or ethylene group, and an alkyleneoxy group such as a ethyleneoxy group or propyleneoxy group) can be used for the cationic polymerization-type UV-curable silicone release agent. The mode by which at least two epoxy groups are bonded to Si may be the same or different. In other words, a polysiloxane is used that contains two or more side chains containing one type or two or more types of epoxy groups. Examples of epoxy group-containing side chains include glycidyl groups, glycidoxy groups (glycidyloxy groups), 3,4-epoxycyclohexyl groups and 2,3-epoxycyclopentyl groups. The epoxy group-containing polysiloxane may be linear, branched or a mixture thereof.

A UV-curable silicone release agent obtained by suitably preparing an epoxy group-containing polysiloxane as described above in accordance with conventionally known methods, or a commercially available product containing such an epoxy group-containing polysiloxane can be used for the UV-curable silicone release agent. An example of a synthesis method for preparing an epoxy group-containing polysiloxane consists of an addition reaction in which an olefin-based epoxy monomer such as 4-vinylcyclohexene oxide, allyl glycidyl ether or 7-epoxy-1-octene is added to polymethylhydrogensiloxane serving as a base polymer using a platinum-based catalyst.

The cationic polymerization-type UV-curable silicone release agent can have a composition that contains one type or two or more types of onium salt-based UV cleavage initiators (onium salt-based photopolymerization initiators) as UV cleavage initiators (photopolymerization initiators) in addition to the polysiloxane. Examples of onium salt-based UV cleavage initiators that can be used include those described in Japanese Patent Application Laid-open Nos. H6-32873, 2000-281965, H11-228702 or Japanese Examined Patent Publication No. H8-26120. Specific examples of these initiators include diaryl iodonium salts, triaryl sulfonium salts, triaryl selenonium salts, tetraaryl sulfonium salts, tetraaryl phosphonium salts and aryl diazonium salts. Diaryl iodonium salts are used particularly preferably.

Examples of diaryl iodonium salts include salts represented by the general formula [Y₂I]⁺X⁻. Similarly, examples of triaryl sulfonium salts, triaryl selenonium salts, tetraaryl phosphonium salts and aryl diazonium salts include salts represented by the general formula [Y₃S]⁺X⁻, [Y₃Se]⁺X⁻, [Y₄P]⁺X⁻ and [YN₂]⁺X⁻, respectively. Here, Y represents an optionally substituted aryl group, I represents an iodine atom, and X⁻ represents a non-nucleophilic, non-basic anion. In addition, S, Se, P and N represent a sulfur atom, selenium atom, phosphorous atom and nitrogen atom, respectively.

Specific examples of the anion (X⁻) include SbF₆⁻, SbCl₆⁻, BF₄⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻, AsF₆⁻, PF₆⁻, HSO₄⁻ and ClO₄⁻. Anions containing elementary antimony (Sb) and anions containing elementary boron (B) are particularly preferable. Particularly preferable examples of the onium salts include Sb-containing diaryl iodonium salts and B-containing diaryl iodonium salts.

Although there are no particular limitations on the amount of UV cleavage initiator contained in the cationic polymerization-type UV-curable silicone release agent provided it is within a range that allows the initiator to function as a catalyst, the amount is, for example, preferably about 0.1 to 8 parts by weight (more preferably 0.3 to 5 parts by weight, and even more preferably 0.5 to 3 parts by weight) based on 100 parts by weight of the epoxy group-containing polysiloxane.

Examples of UV-curable silicone release agents that can be used include those obtained by mixing the suitably prepared or acquired components described above as well as commercially available products containing those components. In addition to those components, fillers, antistatic agents, antioxidants, UV absorbers, plasticizers, colorants (such as dyes or pigments) and other known, commonly used additives may be suitably added.

There are no particular limitations on the material of the substrate on which the release layer composed of the silicon-based release agent is retained (release liner substrate). For example, plastics, paper or single-layer materials or laminates formed from various fibers and the like can be used.

Examples of the plastic substrates that can be used film-like substrates composed of polyolefins such as polyethylene (PE) or polypropylene (PP), polyesters such as polyethylene terephthalate (PET), polyethylene naphthalate (PEN) or polybutylene terephthalate (PBT), polyamides (so-called nylons) and celluloses (so-called cellophanes). Plastic films may be of the non-oriented type or oriented type (uniaxially oriented type or biaxially oriented type).

Examples of the paper substrates that can be used include those composed of Japanese paper, machine-made paper, wood-free paper, glassine paper, kraft paper, top-coated paper and synthetic paper. Although there are no particular limitations on the grammage of the paper substrate, normally that having a grammage of about 50 to 100 g/m² is used suitably.

Examples of various types of fibrous substrates include woven and non-woven fabrics obtained by use alone or blending of various types of fibrous substances (including natural fibers, semi-synthetic fibers and synthetic fibers, examples of which include cotton fiber, staple fiber, manila hemp, pulp, rayon, acetate fiber, polyester fiber, polyvinyl alcohol fiber, polyamide fiber and polyolefin fiber).

Examples of substrates composed of other materials include rubber sheets composed of natural rubber or butyl rubber, foamed sheets composed of foam such as polyurethane foam or polychloroprene rubber foam, metal foils such as aluminum foil or copper foil, and composites thereof.

The release liner in the art disclosed herein preferably has polyethylene laminated onto at least the front side (side having the PSA layer) of paper (preferably, wood-free paper or glassine paper and the like), and the surface thereof is subjected to release treatment (silicone treatment) with a silicone release agent.

Various types of surface modification treatment such as corona discharge treatment, plasma treatment or application of a primer, or various types of surface processing such as embossing, may be carried out as necessary on the surface provided with the release layer in these release liner substrates. In addition, various additives such as fillers (including inorganic fillers and organic fillers), anti-aging agents, antioxidants, ultraviolet absorbers, antistatic agents, lubricants, plasticizers and colorants (such as pigments or dyes) may be incorporated as necessary.

The thickness of the release liner is preferably about 50 μM to 200 μm (and more preferably 60 μm to 160 μm).

A conventionally known method can be employed for applying a release layer to the release liner. For example, a silicone release agent as previously described can be coated onto a substrate using various types of coaters and then dried to form a release layer. Examples of coaters that can be suitably selected for use as the coater include a direct gravure coater, offset gravure coater, roll coater, bar coater and die coater.

Although there are no particular limitations on the thickness of the release layer, the coated thickness can be, for example, about 0.03 μm to 5 μm (and preferably 0.05 μm to 3 μm). If the thickness of the release layer is below this range excessively, adequate peelability may not be obtained. If the thickness of the release layer exceeds the above range excessively, there may be cases in which the amount of silicone transfer tends to increase due to the presence of residual uncured materials.

Although the coated amount of the release agent can be suitably selected corresponding to, for example, the type of PSA used, the type of liner substrate or the type of release agent, the coated amount as solid fraction can be about 0.01 to 10 g/m² (preferably 0.05 to 5 g/m², more preferably 0.5 to 3 g/m² and even more preferably 0.5 to 2 g/m²).

The release agent is dried after being applied to the substrate. Although there are no particular limitations on drying conditions, drying conditions can be suitably selected that are suitable for the release agent used. Typically, the release agent is dried at a temperature of about 80 to 150° C. In the case of using a heat-curable release agent, the drying step and the curing step can be carried out simultaneously by drying while heating. In addition, curing may also be carried out by heating after air-drying. In the case of using an ionizing radiation-curable silicone release agent, the drying step and the curing step can be allowed to proceed simultaneously by carrying out heating and irradiation simultaneously. The curing step can also be carried out after the drying step. In these steps, a drying method and curing method that are suitable for the release agent used can be employed by suitably selecting from conventionally known methods. Each of the conditions relating to formation of the release layer can be suitably set so as to realize a target amount of silicone transfer.

Thus, matters disclosed in this description include a production method of a double-sided PSA sheet that includes: preparing a release liner in which a release layer composed of a silicone release agent is formed on at least a first side of a release liner substrate (wherein, the release layer is formed so that the amount of silicone transfer to Single-Sided PSA Tape No. 31B manufactured by Nitto Denko Corp. is 10 kcps or less per unit surface area equivalent to a 30 mm diameter circle when determined as the X-ray intensity of silicon by X-ray fluorescence analysis), coating a PSA composition containing a PSA component synthesized in an organic solvent onto each side of a non-woven fabric substrate so that the composition penetrates within the substrate (wherein, the substrate has a grammage of 10 to 25 g/m², has tensile strength in the lengthwise direction and widthwise direction of 9 to 20 N/10 mm, respectively, and has a grain ratio of 70 to 140%), forming a PSA layer on each side of the substrate by drying and/or curing the composition (wherein, the PSA layer provided on each side of the substrate penetrates within the substrate, is formed so as to demonstrate a continuous form extending through the inside of the substrate), and laminating the release liner onto at least one of the PSA layers so that the release layer contacts the PSA layer.

The amount of silicone transfer in the art disclosed herein can be measured by X-ray fluorescence analysis in accordance with the previously described method. X-ray fluorescence analysis can be carried out using an XRF analyzer. A commercially available product can be preferably used for the XRF analyzer. Although analyzing crystals can also be suitably selected and used, crystals such as Si—Kα crystals can be used preferably. In addition, although output settings and the like can be suitably selected corresponding to the apparatus used, normally adequate sensitivity can be obtained with an output of about 50 kV and 70 mA.

The PSA sheet disclosed herein is provided with a PSA layer formed from a solvent-type PSA composition as previously described, and is able to provide a high level of adhesive strength since the amount of silicone transfer is 10 kcps or less. Moreover, since the solvent-type PSA composition adequately penetrates the non-woven fabric substrate, resulting in a continuous form in which the PSA layer applied to each side of the substrate contains a PSA that penetrates inside the substrate, the resulting configuration demonstrates superior anchoring of the PSA layer to the substrate. Thus, the PSA sheet is provided with a high level of adhesion performance in which, for example, the 180° peel adhesive strength for an SUS plate (SUS adhesive strength) is 13 N/20 mm or more and the 180° peel adhesive strength for a polypropylene (PP) sheet (PP adhesive strength) is 9.5 N/20 mm or more (characteristic (E)) (and more preferably, the SUS adhesive strength is 13.5 N/20 mm or more and the PP adhesive strength is 10 N/20 mm or more), while at the same time allowing the obtaining of a PSA sheet that demonstrates superior re-peelability in which there is no glue present as determined in glue residue test according to the previously described method (characteristic (F)).

In addition, since the PSA sheet has superior re-peelability as previously described, it is able to be peeled without shredding as determined in a shred test in which a first adhesive side of the sheet is laminated onto an ABS plate, the PSA sheet is pressed onto the ABS plate by passing a 2 kg roller back and forth over the PSA sheet, and the laminated PSA sheet is held for 7 hours at 80° C. and then for 24 hours in an environment at a temperature of 23° C. and RH of 50%, followed by peeling from the ABS plate at a pulling speed of 5 mm/min and a peeling angle of 180° in an environment at a temperature of 23° C. and RH of 50% (characteristic (K).

In addition, the amount of toluene emitted (to be simply referred to as toluene emission level) of the PSA sheet disclosed herein when the sheet is heated for 30 minutes at 80° C. is 20 μg per 1 g of the PSA layer (to also be indicated as, for example, 20 μg/g) or less (characteristic (H)), and the TVOC level is preferably 1000 μg/g or less (characteristic (I)). A double-sided PSA sheet that satisfies these characteristics can be preferably used in applications strongly required to reduce TVOC levels, such as home appliances and office equipment used indoors or automobiles and the like composing confined spaces. The toluene emission level is more preferably 10 μg/g or less, even more preferably 5 μg/g or less, and particularly preferably 3 μg/g or less. The TVOC level is more preferably 500 μg/g or less, and even more preferably 300 μg/g or less. If the toluene emission level and TVOC level exceed the above ranges excessively, the health environment thereof may deteriorate considerably in the case of using the PSA sheet or when using a product in which the PSA sheet is used. Values obtained according to each of the measurement methods indicated below are used for toluene emission level and TVOC level.

[Measurement of Toluene Emission Level]

A sample of a PSA layer of a prescribed size (for example, having a surface area of 5 cm²) is placed in a vial and sealed. The vial is then heated for 30 minutes at 80° C. and 1.0 mL of gas obtained during heating using a head gas auto sampler is injected into a gas chromatography measurement apparatus (GC measurement apparatus) to measure the amount of toluene. The amount of toluene generated (toluene emission level) (μg/g) per 1 g of PSA layer contained in the sample is calculated from the measurement result.

A value obtained by subtracting the weight of the substrate per sample surface area from the weight of the PSA sheet excluding the release liner can be employed as the weight of the PSA layer that serves as a reference for calculating the toluene emission level per 1 g of PSA layer.

[Measurement of TVOC Level]

A vial containing a sample prepared in the same manner as that for measurement of toluene emission level is heated for 30 minutes at 80° C., and 1.0 mL of gas obtained during heating using a head space auto sampler is injected into a GC measurement apparatus. Peak assignment and quantification are then carried out on volatile substances predicted to be present on the basis of materials used to produce the PSA layer (such as monomers used to synthesize the acrylic-based polymer and solvent used to produce an adhesion-imparting resin emulsion to be described later) according to standard substances based on the resulting chromatogram, while other peaks (peaks that are difficult to be assigned) are quantified as toluene, to determine the TVOC level (μg/g) per 1 g of PSA layer contained in the sample.

A value calculated in the same manner as that for measurement of toluene emission level can be employed as the weight of the PSA layer that serves as a reference for calculating the TVOC level per 1 g of the PSA layer.

Gas chromatography measurement conditions are as indicated below for both the measurement of toluene emission level and measurement of TVOC level.

Column: DB-FFAP 1.0 μm (0.535 mmφ×30 m)

Carrier gas: He 5.0 mL/min

Column head pressure: 23 kPa (40° C.)

Injection port: Split (split ratio: 12:1, temperature: 250° C.)

Column temperature: 40° C. (0 min)—<+10° C./min>—250° C. (9 min)

(after raising the temperature from 40° C. to 250° C. at the rate of 10° C./min, the temperature is held at 250° C. for 9 minutes)

Detector: FID (temperature: 250° C.)

Although the following provides an explanation of several examples relating to the present invention, these examples are not intended to limit the present invention. Furthermore, the terms “parts” and “%” in the following explanation are based on weight unless specifically indicated otherwise.

### Example 1

A release liner substrate having a 25 μm thick PE layer laminated on one side of wood-free paper (grammage: 100 g/m²) was prepared. A mixture of a non-transferring, heat-curable solvent-free silicon-based release agent and curing catalyst was coated onto the PE layer of the substrate so a coated amount of 1.1 g/m². This was then dried and cured by holding for 1 minute at 120° C. to obtain a release liner P. The amount of silicone transfer of this release liner P was 0.8 kcps. The peel strength as measured according to a method to be described later was 0.3 N/50 mm. The amount of silicone transfer was measured under the following conditions using the model “ZSX-100e” XRF analyzer manufactured by Rigaku Corp.

X-ray source: Vertical Rh tube

Analysis range: Within a circle having a diameter of 30 mm

Analyzing crystal: Si—Kα

Output: 50 kV, 70 mA

70 parts of BA, 27 parts of 2EHA, 3 parts of AA, 0.1 part of 2-hydroxyethyl acrylate and ethyl acetate were placed in a reaction vessel provided with a condenser, nitrogen feed tube, thermometer and stirrer followed by replacing the inside of the vessel with nitrogen by introducing nitrogen gas while stirring gently. This reaction solution was heated to 70° C. followed by the addition of 0.2 parts of AIBN (polymerization initiator). The polymerization reaction was carried out for 8 hours while holding the system at 70° C. to obtain an ethyl acetate solution of an acrylic-based polymer having a weight average molecular weight of 70×10⁴. 30 parts of “Pencel D-125” manufactured by Arakawa Chemical Industries, Ltd. (polymerized rosin ester having a softening point (ring and ball method) of 125° C.) and 10 parts of “Super Ester A-75” also manufactured by Arakawa Chemical Industries, Ltd. (rosin ester having a softening point (ring and ball method) of 75° C.) were added as tackifiers per 100 parts of the acrylic-based polymer (based on solid fraction) contained in the solution. Moreover, 2 parts of “Colonate L” (isocyanate-based crosslinking agent) manufactured by Nippon Polyurethane Industry Co., Ltd. were added to 100 parts of this composition (based on solid fraction) followed by adjusting the concentration with ethyl acetate to obtain a solvent-type PSA composition having a solid content of 40%.

When the viscosity of this PSA composition at 23° C. was measured using a BH type rotational viscometer manufactured by Tokimec Inc. (rotor speed: 20 rpm), it was found to be 80 Pa·s. In addition, when the shear loss modulus G″ of the PSA layer was separately measured according to the previously described method, the peak temperature was −25° C. Here, the model “ARES” manufactured by Rheometric Scientific Inc. was used for the viscoelasticity measurement apparatus.

The PSA composition was simultaneously applied directly to each side of a non-woven fabric substrate S composed only of manila hemp (MD tensile strength: 13 N/10 mm, CD tensile strength: 11.4 N/10 mm, grain ratio: 88%, thickness: 62 μm, grammage: 18 g/m²) using a die coater arranged on each side with the non-woven fabric interposed there between, and after allowing the PSA composition to penetrate inside the non-woven fabric, the coated non-woven fabric was dried for 5 minutes in an oven at 100° C. followed by winding onto a paper tube (outer diameter: 82 mm) serving as a core together with the release liner to obtain a double-sided PSA sheet as related to Example 1. The total thickness of this PSA sheet was 160 μm.

### Example 2

A double-sided PSA sheet as related to Example 2 was obtained in the same manner as Example 1 with the exception of using a non-woven fabric substrate T (MD tensile strength: 11 N/10 mm, CD tensile strength: 9.9 N/10 mm, grain ratio: 90%, thickness: 53 μm, grammage: 15 g/m²) instead of the non-woven fabric substrate S.

### Example 3

A UV-curable, solvent-free silicone release agent was coated onto a PE layer of a substrate obtained in the same manner as Example 1 instead of the mixture of release agent and catalyst used in Example 1. The coated amount of the release agent was 1.3 g/m². After coating the release agent, the release agent was cured by irradiating with UV light under conditions of illuminance of 2 W/cm² and line speed of 70 m/min using a high-pressure mercury vapor lamp for the light source to obtain a release liner Q. The amount of silicone transfer of this release liner Q was 4.8 kcps. The peel strength was 0.6 N/50 mm.

A double-sided PSA sheet as related to Example 3 was obtained in the same manner as Example 1 with the exception of using the release liner Q instead of the release liner P.

### Example 4

A double-sided PSA sheet as related to Example 4 was obtained in the same manner as Example 1 with the exception of using a non-woven fabric substrate U composed only of manila hemp and wood pulp (MD tensile strength: 7 N/10 mm, CD tensile strength: 6.0 N/10 mm, grain ratio: 85%, thickness: 40 μm, grammage: 13 g/m²) instead of the non-woven fabric substrate S.

### Example 5

A release liner R was obtained in the same manner as Example 1 with the exception of using a general-purpose heat-curable, solvent-free silicone release agent and curing catalyst instead of the release agent and curing catalyst used in Example 1, and making the coated amount of the release agent 1.5 g/m². The amount of silicone transfer of this release liner R was 11.3 kcps. The peel strength was 1.1 N/50 mm. A double-sided PSA sheet as related to Example 5 was obtained in the same manner as Example 1 with the exception of using the release liner R instead of the release liner P.

The peel strengths of the release liners P to R were measured in the following manner. Namely, a piece of PSA tape (Acrylic-Based Double-Sided PSA Tape No. 502 manufactured by Nitto Denko Corp. with a width of 50 mm) having a length of about 20 cm was prepared, and a release liner was laminated onto the adhesive surface exposed by peeling off the yellow release paper, using a hand roller in an environment at 23° C. and 50% RH to produce a test piece. A load of 1 kg was applied to the test piece in an environment at 100° C. followed by holding for 1 hour in an environment at 23° C. and 50% RH. Stress was then measured when the release liner was peeled for a distance of 50 mm under conditions of a peeling angle of 180° and pulling speed of 300 mm/min in an environment at 23° C. and 50% RH using a tensile tester, and the maximum value thereof was defined as peel strength (N/50 mm). Here, an auxiliary plate was used to measure peel strength.

Tensile strengths of the non-woven fabric substrates S to U were measured in the following manner. Namely, test pieces were produced by cutting each non-woven fabric into 10 mm strips so that the MD direction was the lengthwise direction. Each test piece was placed in a “Tensilon” tensile tester manufactured by Shimadzu Corp. at a chuck interval of 100 mm in an environment at 23° C. and 50% RH. The test piece was then pulled in the lengthwise direction under conditions of a pulling speed of 300 min/min, and the maximum tensile strength measured at that time was defined as MD tensile strength. In addition, CD tensile strength was measured in the same manner as MD tensile strength with the exception of producing test pieces in which the CD direction was the lengthwise direction. The percentage of the value of the ratio of CD tensile strength to MD tensile strength ((CD tensile strength/MD tensile strength)×100%) was calculated as the grain ratio.

The types of release liners and non-woven fabric substrates, characteristics and other parameters regarding the double-sided PSA sheets of Examples 1 to 5 are shown in Table 1, while results of the following evaluations are shown in Table 2.

### [Adhesion Performance]

[SUS Plate 180° Peel Adhesive Strength]

Each double-sided PSA sheet was lined by laminating a PET film having a thickness of 25 μm. The lined PSA sheet was cut to a rectangular shape measuring 20 mm×200 mm to produce a test piece. The release liner was peeled from the test piece, and the exposed adhesive surface was laminated onto a stainless steel (SUS: B304) plate serving as an adherend by passing a 2 kg roller back and forth thereon. After holding this for 30 minutes in an environment at 23° C. and 50% RH, SUS 180° peel adhesive strength was measured using a “Tensilon” tensile tester manufactured by Shimadzu Corp. in compliance with JIS Z 0237 in environment at 23° C. and 50% RH and under conditions of a peeling angle of 180° and pulling speed of 300 mm/min.

[PP plate 180° Peel Adhesive Strength]

PP plate 180° peel adhesive strength was measured in the same manner as SUS plate 180° peel adhesive strength with the exception of using a PP plate instead of an SUS plate for the adherend.

### [Re-Peelability]

[Intra-Layer Destruction Surface Area Ratio (Intra-Layer Destruction Test)]

Each double-sided PSA sheet was cut to 15 mm×15 mm, the release liner was peeled from the prepared test pieces, and each adhesive surface was laminated to aluminum foil having a thickness of 0.1 mm and measuring 20 mm×100 mm. After holding this for 24 hours at 60° C., the test piece was allowed to cool to room temperature (23° C.) and the aluminum foil was T-peeled at a speed of about 10 m/min while holding onto both ends of the aluminum foil with the hands. The test pieces were observed visually after peeling, and the ratio of the surface area of the non-woven fabric substrate that underwent intra-layer destruction to the total surface area of the substrate (15 mm×15 mm) was estimated as a percentage.

[Shred Test]

Each double-sided PSA sheet was lined by laminating with a non-woven fabric (“Vi-Black DS-25NK”, trade name, Japan Vilene Co., Ltd.) serving as an adherend followed by pressing the fabric onto the PSA sheet with a hand roller. This was then cut to a width of 20 mm and length of 100 mm to produce a test piece. The release liner was then peeled from the test piece, and the exposed adhesive surface was laminated to an ABS plate having a thickness of 2 mm (“ABS-N-WN”, trade name, Shin-Kobe Electric Machinery Co., Ltd.) serving as an adherend followed by pressing the test piece onto the ABS plate by passing a 2 kg roller back and forth thereon and holding the resulting laminate for 7 days at 80° C. and then for 24 hours at 23° C. and 50% RH. Subsequently, the test piece was peeled by hand from the ABS plate in an environment at 23° C. and 50% RH and under conditions of a pulling speed of about 5 mm/min and peel angle of 180° to observe the status of the PSA sheet and adherend after peeling and evaluate shredding to one of the following two levels.

G (Good): Shredding of the sheet did not occur

P (Poor): Shredding of the sheet occurred

[Glue Residue Test]

The surface of the adherend was observed after the peeling carried out in the shred test, and the presence of glue residue was evaluated to one of the three levels indicated below.

G (Good): No glue residue present (residue PSA layer)

I (Intermediate): Glue residue present over about 3% or less of adherend surface

P (Poor): Glue present over more than 3% of adherend surface

### [VOCs Emission Levels]

A value of about 0.91 g was used for the weight of the PSA layer contained in 1 g of each double-sided PSA sheet when calculating the following toluene emission level and TVOC level.

[Toluene Emission Level]

The toluene emission level per 1 g of PSA layer was measured for each double-sided PSA sheet according to the method previously described. As a result, toluene emission levels were within the range of 2 to 3 μg/g for each of the PSA sheets of Examples 1 to 5.

[TVOC Level]

The TVOC level per 1 g of PSA layer was measured for each double-sided PSA sheet according to the method previously described. The same test pieces as those used during measurement of toluene emission level were used. As a result, TVOC levels were within the range of 200 to 250 μg/g for each of the double-sided PSA sheets of Examples 1 to 5.

[Curved Surface Conformability]

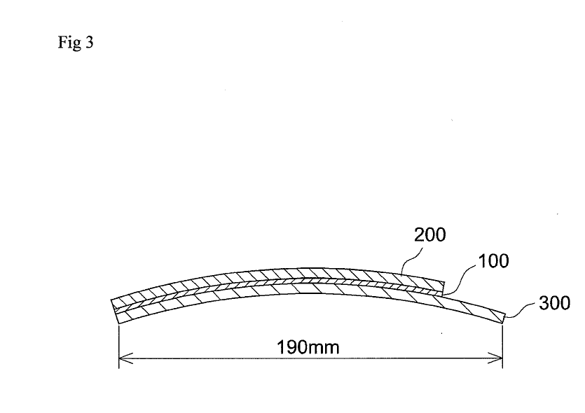

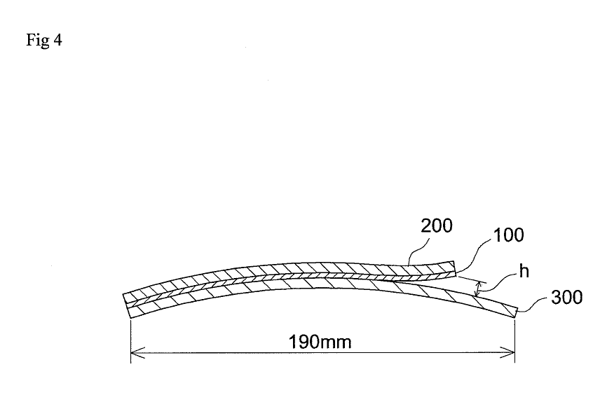

Each double-sided PSA sheet was cut to a size of 20 mm wide and 180 mm long and lined by laminating with an aluminum sheet having a thickness of 0.4 mm of the same size to produce each test piece. The release liner was peeled from each test piece, and after pressing the exposed adhesive surface onto a PP plate having a thickness of 2 mm and cut to a size of 30 mm×200 mm using a laminator in an environment at 23° C. and 50% RH, the laminate was held for 24 hours in the same environment. Next, as shown in FIG. 7, each laminate was bent into a curved shape having an arc length of 190 mm (FIG. 3). This was then held for 72 hours in an environment at 70° C. followed by measurement of the distance h (mm) by which the end of the test piece lifted from the surface of the PP plate (FIG. 4). Reference numerals 100, 200 and 300 in FIGS. 3 and 4 indicate the double-sided PSA sheet from which the release liner had been removed, the aluminum sheet and the PP plate, respectively.

TABLE 1

| | Release Liner | | | Non-Woven Fabric Substrate | | | | |
|---|---|---|---|---|---|---|---|---|
| | | | Peel | | | Peel | | |
| | | Silicone | strength | | Gramm- | strength | | Grain |
| Exam- | | transfer | (N/50 | | age | (N/10 mm) | | ratio |
| ple | Type | (kcps) | mm) | Type | (g/m²) | MD | CD | (%) |
| 1 | P | 0.8 | 0.3 | S | 18 | 13 | 11.4 | 88 |
| 2 | P | 0.8 | 0.3 | T | 15 | 11 | 9.9 | 90 |
| 3 | Q | 4.8 | 0.6 | S | 18 | 13 | 11.4 | 88 |
| 4 | P | 0.8 | 0.3 | U | 13 | 7 | 6.0 | 85 |
| 5 | R | 11.3 | 1.1 | S | 18 | 13 | 11.4 | 88 |

TABLE 2

| | PSA Sheet | | | | | | | |
|---|---|---|---|---|---|---|---|---|
| | Adhesive | | Re-peelability | | | VOCs | | Curved |
| | strength | | Intra-layer | | | emission levels | | surface |
| | (N/20 mm) | | destruction | | Glue | (μg/g) | | conformability |
| Example | SUS | PP | (%) | Shredding | residue | Toluene | TVOC | (mm) |
| 1 | 15.5 | 11.8 | 3 | G | G | 3 | 300 | 1.0 |
| 2 | 15.3 | 12.0 | 2 | G | G | 3 | 300 | 0.5 |
| 3 | 14.0 | 10.2 | 3 | G | G | 3 | 300 | 2.0 |
| 4 | 12.8 | 10.3 | 1 | P | G | 3 | 300 | 1.0 |
| 5 | 11.3 | 9.0 | 3 | G | G | 3 | 300 | 4.0 |

As shown in Tables 1 and 2, the double-sided PSA sheet of Example 4, which uses a non-woven fabric substrate having values for both MD and CD tensile strength of less than 9 N/10 mm (namely, does not satisfy characteristic (B)) tended to have weak SUS adhesive strength and demonstrated shredding in a shred test carried out to evaluate one aspect of re-peelability. In addition, although the double-sided PSA sheet of Example 5, which uses a release liner provided with a release layer having silicone transfer in excess of 10 kcps (namely, does not satisfy characteristic (D)) demonstrated satisfactory results for re-peelability, both SUS adhesive strength and PP adhesive strength were inadequate with respect to adhesion performance. On the other hand, the double-sided PSA sheets of Examples 1 to 3, which satisfy each of characteristics (A) to (D), simultaneously demonstrated superior adhesive strength capable of accommodating both metal parts and plastic parts, as well as satisfactory re-peelability such that there was no glue residue present on the adherend and there was no shredding of the sheet during re-peeling. Moreover, the double-sided PSA sheets of Examples 1 to 3 also demonstrated superior results in the test of curved surface conformability, with each of the sheets demonstrating a lift distance from the adherend of 3 mm or less (2 mm or less in the table above). In particular, the double-sided PSA sheets of Examples 1 and 2, which used a non-transfer, heat-curable solvent-free silicon-based release agent, exhibited superior re-peelability as well as even higher levels of adhesive strength, demonstrating SUS adhesive strength of 15 N/20 nun or more and PP adhesive strength of about 12 N/20 mm.

Although the above has provided a detailed explanation of specific examples of the present invention, the examples are intended to merely be exemplary, and do not limit the scope of the claims. The technology described in the claims includes various modifications and alterations of the specific examples indicated above.

What is claimed is:

1. A double-sided pressure-sensitive adhesive sheet, comprising: a substrate composed of a non-woven fabric; a pressure-sensitive adhesive layer applied to each side of the substrate; and a release liner laminated onto at least one of the pressure-sensitive adhesive layers,
wherein all of the following conditions are satisfied:
the pressure-sensitive adhesive layer contains, as a pressure-sensitive adhesive component, a polymer synthesized in an organic solvent; and
the release liner has a release layer composed of a silicone release agent on at least the side of the pressure-sensitive adhesive layer, and
the pressure-sensitive adhesive sheet satisfies all of the following characteristics:
(A) the non-woven fabric has a grammage of 10 to 25 g/m²;
(B) the non-woven fabric has tensile strength in the lengthwise direction and tensile strength in the widthwise direction both falling within the range of 9 to 20 N/10 mm;
(C) the non-woven fabric has a grain ratio within the range of 70 to 140%; and
(D) the release layer has an amount of silicone transfer to Single-Sided Pressure-Sensitive Adhesive Tape No. 31B manufactured by Nitto Denko Corp. of 10 kcps or less per unit surface area equivalent to a 30 mm diameter circle when determined as the X-ray intensity of silicon by X-ray fluorescence analysis.

2. The pressure-sensitive adhesive sheet according to claim 1, which further satisfies the following characteristics:
(E) 180° peel adhesive strength for a stainless steel plate is 13 N/20 mm or more, and 180° peel adhesive strength for a polypropylene plate is 9.5 N/20 mm or more; and
(F) glue residue is not present on an acrylonitrile-butadiene-styrene copolymer resin (ABS) sheet in a glue residue test in which the pressure-sensitive adhesive sheet is laminated onto the ABS plate for 7 days at 80° C. and then held for 24 hours at room temperature followed by peeling at a pulling speed of 5 mm/min and a peeling angle of 180°.

3. The pressure-sensitive adhesive sheet according to claim 1, which further satisfies the following characteristic:
(G) in an intra-layer destruction test in which each adhesive side is lined with a non-peeling substrate, held for 24 hours at 60° C., then cooled to room temperature and subjected to T-peeling at a peeling speed of 10 m/min, the pressure-sensitive adhesive sheet has a surface area, over which intra-layer destruction has occurred in the non-woven fabric substrate, of 10% or less of the total surface area of the substrate.

4. The pressure-sensitive adhesive sheet according to claim 1, wherein the organic solvent at least contains ethyl acetate.

5. The pressure-sensitive adhesive sheet according to claim 1, wherein the silicone release agent is a solvent-free silicone.

6. The pressure-sensitive adhesive sheet according to claim 1, wherein the silicone release agent is a heat-curable silicone.

7. The pressure-sensitive adhesive sheet according to claim 1, which further satisfies the following characteristics:
(H) the amount of toluene emitted from the pressure-sensitive adhesive sheet when the pressure-sensitive adhesive sheet is held for 30 minutes at 80° C. is 20 μg or less per 1 g of the pressure-sensitive adhesive layer; and
(I) the total amount of volatile organic compounds emitted from the pressure-sensitive adhesive sheet when the pressure-sensitive adhesive sheet is held for 30 minutes at 80° C. is 1000 μg or less per 1 g of the pressure-sensitive adhesive layer.

8. The pressure-sensitive adhesive sheet according to claim 1, wherein the pressure-sensitive adhesive layer contains, as a pressure-sensitive adhesive component, an acrylic-based polymer obtained by polymerizing a monomer starting material at least containing an acrylic-based monomer represented by the general formula: CH₂═C(R¹)COOR² (wherein, R¹ represents a hydrogen atom or a methyl group, and R² represents an alkyl group having 2 to 14 carbon atoms).

9. The pressure-sensitive adhesive sheet according to claim 1, wherein the pressure-sensitive adhesive layer contains a polymerized rosin ester having a softening point of 80 to 180° C. as a tackifier.

10. The pressure-sensitive adhesive sheet according to claim 9, wherein the pressure-sensitive adhesive layer contains 5 to 50 parts by weight of the polymerized rosin ester based on 100 parts by weight of the polymer used as the pressure-sensitive adhesive component.

11. The pressure-sensitive adhesive sheet according to claim 9, wherein the pressure-sensitive adhesive layer further contains a rosin ester having a softening point of lower than 120° C. as a tackifier.

12. The pressure-sensitive adhesive sheet according to claim 1, which further satisfies the following characteristic:
(J) a shear loss modulus G″ (Pa) of the pressure-sensitive adhesive layer, which is measured as a function of temperature at a frequency of 1 Hz using a sample obtained by stamping out the pressure-sensitive adhesive layer into a columnar shape having a diameter of 7.5 mm and a height of 1 mm, reaches a maximum value within a temperature range of −45 to −20° C.

13. The pressure-sensitive adhesive sheet according to claim 1, which further satisfies the following characteristic:
(K) there is no shredding of the pressure-sensitive adhesive sheet in a shred test in which one side of the pressure-sensitive sheet is laminated onto an ABS plate as an adherend, the pressure-sensitive adhesive sheet is pressed onto the ABS plate by passing a 2 kg roller back and forth over the pressure-sensitive adhesive sheet, and the laminated pressure-sensitive adhesive sheet is held for 7 hours at 80° C. and then for 24 hours at a temperature of 23° C. and a relative humidity of 50%, followed by peeling from the adherend at a pulling speed of 5 mm/min and a peeling angle of 180° in an environment at 23° C. and 50% relative humidity.

14. The pressure-sensitive adhesive sheet according to claim 1, which further satisfies the following characteristic:
(L) a lift distance from the surface of an adherend is 3 mm or less in a curved surface conformability test.

15. The pressure-sensitive adhesive sheet according to claim 1, which is used to fix a part scheduled to be recycled.

16. The pressure-sensitive adhesive sheet according to claim 2, which further satisfies the following characteristic:
(G) in an intra-layer destruction test in which each adhesive side is lined with a non-peeling substrate, held for 24 hours at 60° C., then cooled to room temperature and subjected to T-peeling at a peeling speed of 10 m/min, the pressure-sensitive adhesive sheet has a surface area, over which intra-layer destruction has occurred in the non-woven fabric substrate, of 10% or less of the total surface area of the substrate; and
(K) there is no shredding of the pressure-sensitive adhesive sheet in a shred test in which one side of the pressure-sensitive sheet is laminated onto an ABS plate as an adherend, the pressure-sensitive adhesive sheet is pressed onto the ABS plate by passing a 2 kg roller back and forth over the pressure-sensitive adhesive sheet, and the laminated pressure-sensitive adhesive sheet is held for 7 hours at 80° C. and then for 24 hours at a temperature of 23° C. and a relative humidity of 50%, followed by peeling from the adherend at a pulling speed of 5 mm/min and a peeling angle of 180° in an environment at 23° C. and 50% relative humidity.

17. The pressure-sensitive adhesive sheet according to claim 16, which further satisfies the following characteristics:
(H) the amount of toluene emitted from the pressure-sensitive adhesive sheet when the pressure-sensitive adhesive sheet is held for 30 minutes at 80° C. is 20 μg or less per 1 g of the pressure-sensitive adhesive layer; and
(I) the total amount of volatile organic compounds emitted from the pressure-sensitive adhesive sheet when the pressure-sensitive adhesive sheet is held for 30 minutes at 80° C. is 1000 μg or less per 1 g of the pressure-sensitive adhesive layer.

18. The pressure-sensitive adhesive sheet according to claim 17, which further satisfies the following characteristic:
(J) a shear loss modulus G″ (Pa) of the pressure-sensitive adhesive layer, which is measured as a function of temperature at a frequency of 1 Hz using a sample obtained by stamping out the pressure-sensitive adhesive layer into a columnar shape having a diameter of 7.5 mm and a height of 1 mm, reaches a maximum value within a temperature range of −45 to −20° C.

19. The pressure-sensitive adhesive sheet according to claim 18, which further satisfies the following characteristic:
(L) a lift distance from the surface of an adherend is 3 mm or less in a curved surface conformability test.

20. The pressure-sensitive adhesive sheet according to claim 10, wherein the pressure-sensitive adhesive layer further contains a rosin ester having a softening point of lower than 120° C. as a tackifier.
